(19) United States
(12) Patent Application Publication
(10) Pub. No.: US 2026/0237294 A1
(43) Pub. Date: Aug. 13, 2026

(54) METHOD AND VEHICLE FOR MEASURING THE QUALITY OF A TRAFFIC INFRASTRUCTURE ELEMENT

(71) Applicant: VOLKSWAGEN AKTIENGESELLSCHAFT, Wolfsburg (DE)

(72) Inventors: Johannes Hartog, Calberlah (DE); Niklas Puller, Braunschweig (DE)

(21) Appl. No.: 19/154,348

(22) PCT Filed: Jul. 27, 2023
(86) PCT No.: PCT/EP2023/070861

§ 371 Date: Aug. 6, 2025

(30) Foreign Application Priority Data
Feb. 21, 2023 (DE) 102023201542.0

(51) Int. Cl. G08G 1/01; G06Q 10/20; H04W 4/44

(52) U.S. Cl. CPC G08G 1/0116; G06Q 10/20; G08G 1/0112; H04W 4/44

(57) ABSTRACT

Technologies and techniques relating to a vehicle include receiving a first message from a traffic infrastructure element, the first message being based on a first sensor value obtained by the traffic infrastructure element. A second sensor value, corresponding to the first sensor value, is obtained, and a second message, based on the second sensor value, is transmitted to the traffic infrastructure element. Additionally, technologies and techniques are provided for a traffic infrastructure element, as well as a vehicle and a traffic infrastructure element configured to implement the respective functionalities.

### RELATED APPLICATIONS

The present application claims priority to International Patent Application No. PCT/EP2023/070861 to Hartog, et al., filed Jul. 27, 2023, which claims priority from German Patent App. No. DE 10 2023 201 542.0, filed Feb. 21, 2023, the contents of each being incorporated by reference in their entirety herein.

### TECHNICAL FIELD

The present disclosure relates to technologies and techniques for a vehicle, including a method for measuring the quality of a roadside traffic infrastructure unit. Aspects of the present disclosure furthermore relate to a method of a traffic infrastructure element and to a vehicle and to a traffic infrastructure element, which are configured to carry out the particular methods.

### BACKGROUND

Traffic infrastructure elements detect traffic situations by means of a sensor system and transmit the ascertained data to surrounding road users. Calibration errors may occur during the installation or the operation of traffic infrastructure elements, for example as a result of a displacement or inclination of the sensor used compared to the target position. As a result, the transmitted measured data may no longer correspond to reality, but a difference exists between a transmitted object and the real counterpart thereof.

WO 2022 098 147 A1 describes a method and a device for processing images based on V2X messages in wireless communication systems. The patent relates to the use of V2X messages for identifying objects in an image by using additional pieces of information via the sending device. The goal is to recognize objects that send V2X messages in an image and to process them accordingly.

The paper “Reinforcing traffic safety by using CAM to verify velocity accuracy” by Erik de Britto e Silva et al relates to the use of Cooperative Awareness Messages (CAM) in intelligent transport systems (C-ITS) to check the accuracy of the speed transmitted by vehicles. The speed sent by a vehicle is compared to a speed detected by an external measuring station (RSU). If variances are identified, a warning can be output to recognize errors or manipulations.

KR 2021 0 103 607 A describes a system for the communication between autonomous vehicles and road-side units (RSU). It comprises methods for enhancing vehicle safety by exchanging pieces of information, such as map data, sensor data, and pieces of vehicle information.

To recognize these errors, the traffic infrastructure elements used must be checked to ensure correct calibration on a regular basis. For this purpose, trips can be carried out with a reference vehicle at the traffic infrastructure elements. This method of checking the traffic infrastructure elements that are in operation on a regular basis is time-consuming and requires the presence of a reference vehicle including a driver, and possibly a technician, on-site.

Moreover, the quality of the data of the traffic infrastructure elements can vary, depending on the sensors and algorithms used. For example, manufacturer A may provide a better data quality than manufacturer B, even if the sensor is set correctly. In addition, the information regarding the sensors used can also correspond to reality with a higher or lower degree of precision (for example, information regarding the sensor range, updating frequency, and the like).

Without a certification process of the sending traffic infrastructure elements, the receiving vehicle can therefore only inadequately assess how much the data of a traffic infrastructure element can be trusted.

### SUMMARY

Aspects of the present disclosure are directed to overcoming or reducing at least some of the disadvantages of the prior art and to provide methods for enhanced quality measurement of a traffic infrastructure element.

Aspects of the present disclosure are directed to technologies and techniques relating to a vehicle, a method for a traffic infrastructure element, a vehicle, and a traffic infrastructure element according to the claims. Preferred refinements are the subject matter of the subclaims.

In some examples, a method of a vehicle is disclosed. Within the meaning of the present disclosure, a vehicle preferably comprises means of transportation designed to transport people and/or loads on earth, in the air and/or in space. The vehicle is preferably a passenger car comprising an internal combustion engine, an electric motor or a hybrid motor.

In some examples, the method comprises receiving a first message from a traffic infrastructure element as one method step. The first message is preferably received directly or indirectly. The first message is preferably received by way of direct communication according to the ITS-G5 and/or the C-V2X standards and/or by way of indirect communication via a back-end. Particularly preferably, the first message is a collective perception message (CPM) according to the ETSI TR 103 562 or ETSI TS 103 324 standard.

In some examples, a method of a traffic infrastructure element is disclosed. The method comprises transmitting a first message to at least one vehicle as a first step. First messages are preferably transmitted to a plurality of vehicles. The first message is preferably transmitted directly or indirectly. The first message is preferably transmitted by way of direct communication according to the ITS-G5 and/or the C-V2X standard and/or by way of indirect communication via a back-end. Particularly preferably, the first message is a collective perception message (CPM) according to the ETSI TR 103 562 or ETSI TS 103 324 standard. The first message is based on a first sensor value ascertainable by the traffic infrastructure element. The first message preferably includes pieces of information regarding the first sensor value. The first message is preferably the first message described above in the method of a vehicle.

In some examples, a vehicle is disclosed, such as a passenger car comprising an internal combustion engine, an electric motor or a hybrid motor. The vehicle comprises a sensor, preferably a first sensor. The first sensor is designed to detect a sensor value, preferably a second sensor value as described above. The vehicle furthermore comprises a communication module designed for wireless communication with a traffic infrastructure element. The vehicle furthermore comprises a control device, which is designed to carry out the above-described method of a vehicle.

Preferred specific embodiments of the vehicle according to the present disclosure correspond to preferred specific embodiments of the method of a vehicle according to the disclosure, as described above. Advantages of the vehicle correspond to the advantages of the method of a vehicle, as described above.

In some examples, a traffic infrastructure element is disclosed. The traffic infrastructure element comprises a sensor, preferably a second sensor. The second sensor is designed to detect a sensor value, preferably a first sensor value as described above. The traffic infrastructure element furthermore comprises a communication unit designed for wireless communication with a vehicle. The traffic infrastructure element furthermore comprises a memory designed to store a plurality of data. The traffic infrastructure element furthermore comprises a control unit, which is designed to carry out the above-described method of a traffic infrastructure element.

Preferred specific embodiments of the traffic infrastructure element according to the present disclosure correspond to preferred specific embodiments of the method of a traffic infrastructure element according to the disclosure, as described above. Advantages of the traffic infrastructure element correspond to the advantages of the method of a traffic infrastructure element, as described above.

In some examples, a computer program is disclosed, encompassing commands that, when the program is being executed by a computer, such as a control device of a vehicle, prompt the computer to carry out the method of a vehicle, as described above.

A further aspect of the disclosure relates to a computer program encompassing commands that, when the program is being executed by a computer, such as a control unit of a traffic infrastructure element, prompt the computer to carry out the method of a traffic infrastructure element, as described above.

Further preferred embodiments of the invention are derived from the remaining features described in the subclaims.

The various embodiments of the invention described in the present application can advantageously be combined with one another, unless indicated otherwise in the specific instance.

### BRIEF DESCRIPTION OF THE DRAWINGS

Aspects of the present disclosure will be described hereafter in exemplary embodiments based on the associated drawings. In the drawings:

FIG. 1 illustrates a method of a vehicle according to some aspects of the present disclosure;

FIG. 2 illustrates a method of a traffic infrastructure element according to some aspects of the present disclosure;

FIG. 3 illustrates an exemplary application for the method of a vehicle and the method of a traffic infrastructure element according to some aspects of the present disclosure;

FIG. 4 illustrates a vehicle and a traffic infrastructure element according to some aspects of the present disclosure; and

FIG. 5 illustrates a further exemplary application of the vehicle and of the traffic infrastructure element according to some aspects of the present disclosure.

### DETAILED DESCRIPTION

In some embodiments, the first message is derived from a first sensor value obtained by the traffic infrastructure element. The first message typically includes information related to the first sensor value, which preferably pertains to the vehicle. The first sensor value is preferably obtained using at least one sensor selected from radar, LIDAR, sonar, GPS, odometry, inertial, or camera sensors of the traffic infrastructure element.

As a subsequent step, the method includes obtaining a second sensor value, which corresponds to the first sensor value. The second sensor value preferably relates to the vehicle's surroundings and is typically obtained using at least one sensor selected from radar, LIDAR, sonar, GPS, odometry, inertial, or camera sensors of the vehicle.

In a further step of the method, a second message is transmitted to the traffic infrastructure element, the second message being based on the second sensor value and typically including the second sensor value. Preferably, the second message is transmitted via a communication method different from that used for the first message. The second message may also be transmitted to other entities in an autonomous driving system, such as additional vehicles or servers.

Some aspects of the present disclosure provide a method configured to obtain and transmit additional sensor values corresponding to specific first sensor values, enabling verification of the first sensor values.

In a preferred embodiment, the method further includes determining a variance between the first sensor value and the second sensor value. Preferably, an offset between the first and second sensor values is identified, or an overestimation or underestimation of confidence values is detected based on the first and second sensor values. The identification of the offset or the overestimation/underestimation is preferably based on multiple first and second sensor values. More preferably, the variance is calculated based on the identified offset or the detected overestimation/underestimation. The first message typically includes the first sensor value, and the variance is determined as the difference between the first sensor value and the second sensor value, providing a straightforward method for variance calculation. The second message is preferably based on the variance and, more preferably, includes the variance. This configuration enables the vehicle to independently verify potentially inaccurate sensor values from the traffic infrastructure element, with the computational effort for determining the variance performed by the vehicle. Additionally, when the second message includes the variance, it is advantageous that neither the first nor the second sensor value needs to be transmitted, thereby conserving resources. The second message, including the variance, can also be transmitted to other entities in the autonomous driving system to inform them of the variance.

In another preferred embodiment, the first message includes a first derivative value derived from the first sensor value, such as a vehicle position calculated from a first sensor value obtained by a distance sensor of the traffic infrastructure element. A second derivative value is preferably calculated based on the second sensor value. The relationship between the first derivative value and the first sensor value is preferably consistent with the relationship between the second derivative value and the second sensor value. Alternatively, the relationship between the first derivative value and the first sensor value may differ from that between the second derivative value and the second sensor value. For example, the second derivative value may be a position calculated from a second sensor value obtained by a GPS sensor. Preferably, the variance is determined as the difference between the first derivative value and the second derivative value. In this embodiment, the first and/or second messages typically include information about the derivative values, such as the method used to determine them. The second message preferably includes both the first derivative value and the second derivative value. This approach advantageously allows the vehicle to verify a broader range of sensor types used by the traffic infrastructure element. It is particularly beneficial for verifying sensors in the traffic infrastructure element that are not present in the vehicle.

In a further preferred embodiment, the first message includes sensor-based information regarding multiple vehicles. This information preferably includes first sensor values and/or first derivative values derived from the first sensor values. For example, the first message may include a current traffic scenario, encompassing information about all vehicles in the vicinity of the traffic infrastructure element. The method preferably includes obtaining vehicle-specific information based on the first message. As a further step, the method determines the variance based on the vehicle-specific information and the second sensor value. In this embodiment, the vehicle advantageously selects information relevant for verifying the traffic infrastructure element from a plurality of data points. Notably, this information can be derived from messages, such as collective perception messages (CPMs), that are routinely exchanged among various entities in the autonomous driving system and not specifically generated for verification purposes.

In another preferred embodiment, additional sensor values received from the traffic infrastructure element are corrected based on the variance. Preferably, additional derivative values received from the traffic infrastructure element are also corrected based on the variance. This approach enables the vehicle to utilize data from the traffic infrastructure element even when such data are known to be erroneous, by correcting the errors within the vehicle itself. In the method, it is likewise preferred that further first messages are only evaluated when the variance drops below a specified first limit value. Preferably, all further messages that are sent by the traffic infrastructure element are only evaluated when the variance drops below the first limit value. In this way, messages of a traffic infrastructure element that is known to be particularly erroneous are advantageously not processed, resulting in greater vehicle safety.

In a further step, the method of a traffic infrastructure element includes receiving a second message from at least one vehicle. Preferably, second messages are received from multiple vehicles. The second message is based on a second sensor value obtained by the at least one vehicle, corresponding to the first sensor value. The second message typically includes the second sensor value and is preferably transmitted using a different communication method than the first message. The second message is preferably the same as the second message described in the method of a vehicle.

Some aspects of the present disclosure provide that the traffic infrastructure element receives messages containing corresponding sensor values from vehicles and the traffic infrastructure element, which can be used to assess the quality of the traffic infrastructure element. These received messages may also be used to evaluate the quality of the vehicles.

In a preferred embodiment, the method of a traffic infrastructure element further includes determining a variance based on the second message and a first sensor value obtained by the sensor of the traffic infrastructure element. Preferably, an offset between the first and second sensor values is identified, or an overestimation or underestimation of confidence values is detected based on the first and second sensor values. The identification of the offset or the overestimation/underestimation is preferably based on multiple first and second sensor values.

More preferably, the variance is calculated based on the identified offset or the detected overestimation/underestimation. The second message typically includes the second sensor value, and the variance is determined as the difference between the first sensor value and the second sensor value, enabling a straightforward variance calculation. This configuration allows the traffic infrastructure element to independently verify potentially inaccurate sensor values using this embodiment.

In another preferred embodiment, the second message includes a second derivative value derived from the second sensor value, such as a vehicle position calculated from a second sensor value obtained by a GPS sensor of the vehicle. A first derivative value is preferably calculated based on the first sensor value. The relationship between the first derivative value and the first sensor value is preferably consistent with the relationship between the second derivative value and the second sensor value. Alternatively, the relationship between the first derivative value and the first sensor value may differ from that between the second derivative value and the second sensor value. For example, the first derivative value may be a vehicle position calculated from a first sensor value obtained by a distance sensor of the traffic infrastructure element. Preferably, the variance is determined as the difference between the first derivative value and the second derivative value. In this embodiment, the first and/or second messages typically include information about the derivative values, such as the method used to determine them. This approach enables verification of a broader range of sensor types used by the traffic infrastructure element. It is particularly beneficial for verifying sensors in the traffic infrastructure element that are not present in the vehicle.

In a further preferred embodiment, the first message includes a first sensor value obtained by the sensor of the traffic infrastructure element. The second message preferably includes a variance based on the second sensor value, obtained by the at least one vehicle, and the first sensor value. In other words, the variance is preferably calculated by the vehicle and received by the traffic infrastructure element via the second message. This configuration advantageously shifts the computational effort for determining the variance to the vehicle. Additionally, it is beneficial that neither the first nor the second sensor value needs to be transmitted via the second message, conserving resources.

The method preferably further includes aggregating the variances as variance data in a memory of the traffic infrastructure element. The variance data are preferably based on calculations performed by the traffic infrastructure element and/or the vehicle. In other words, the aggregated variance data include variances calculated by the at least one vehicle and transmitted via the second message and/or determined by the traffic infrastructure element itself.

In another preferred embodiment, the method of a traffic infrastructure element further includes determining a mean variance based on the variance data. The mean variance is preferably calculated as the mean or median of the variances. This embodiment enables quality assessment of the traffic infrastructure element based on multiple variances, reducing susceptibility to errors.

In a further preferred embodiment, the method of a traffic infrastructure element includes initiating maintenance of the traffic infrastructure element based on the variance data. Preferably, the mean variance is compared to a predetermined threshold value for this purpose. Maintenance is preferably initiated when the mean variance exceeds the threshold value, ensuring that significantly erroneous traffic infrastructure elements are decommissioned and repaired. This approach enhances the safety of the autonomous driving system.

In another preferred embodiment, the method includes correcting additional sensor values obtained by the sensor of the traffic infrastructure element based on the variance data. These sensor values are preferably corrected until maintenance is performed. This ensures that, once an issue is identified, the traffic infrastructure element no longer provides erroneous sensor values, even before maintenance is completed.

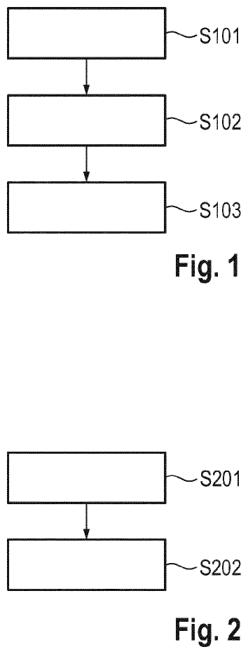

FIG. 1 shows a method of a vehicle, such as a passenger car comprising an internal combustion engine, an electric motor or a hybrid motor, according to a preferred specific embodiment of the present disclosure.

The method comprises receiving a first message from a traffic infrastructure element as a method step S101. In particular, the first message is a collective perception message (CPM) according to the ETSI TR 103 562 or ETSI TS 103 324 standard. The first message is based on a first sensor value ascertainable by the traffic infrastructure element.

As a further method step S102, the method comprises ascertaining a second sensor value. The second sensor value is ascertained corresponding to the first sensor value. The two sensor values in particular relate to the vehicle and are ascertained by at least one radar, LIDAR, sonar, GPS, odometry, inertial and/or camera sensor of the vehicle or of the traffic infrastructure element.

In a further method step S103, a second message is transmitted to the traffic infrastructure element. The second message is based on the second sensor value ascertained in the preceding method step S102.

FIG. 2 shows a method of a traffic infrastructure element according to a preferred specific embodiment of the present disclosure. The method comprises transmitting a first message to at least one vehicle as a first step S201. In particular, the first message is a collective perception message (CPM) according to the ETSI TR 103 562 or ETSI TS 103 324 standard and is transmitted to a plurality of vehicles. The first message is based on a first sensor value ascertainable by the traffic infrastructure element. In particular, the first message is the first message received in step S101 of the method of a vehicle, as described above.

In a further method step S202, the method comprises receiving a second message from the at least one vehicle. The second message is based on a second sensor value detected by the at least one vehicle and corresponding to the first sensor value. In particular, the second message is the second message transmitted in step S103 of the method of a vehicle, as described above.

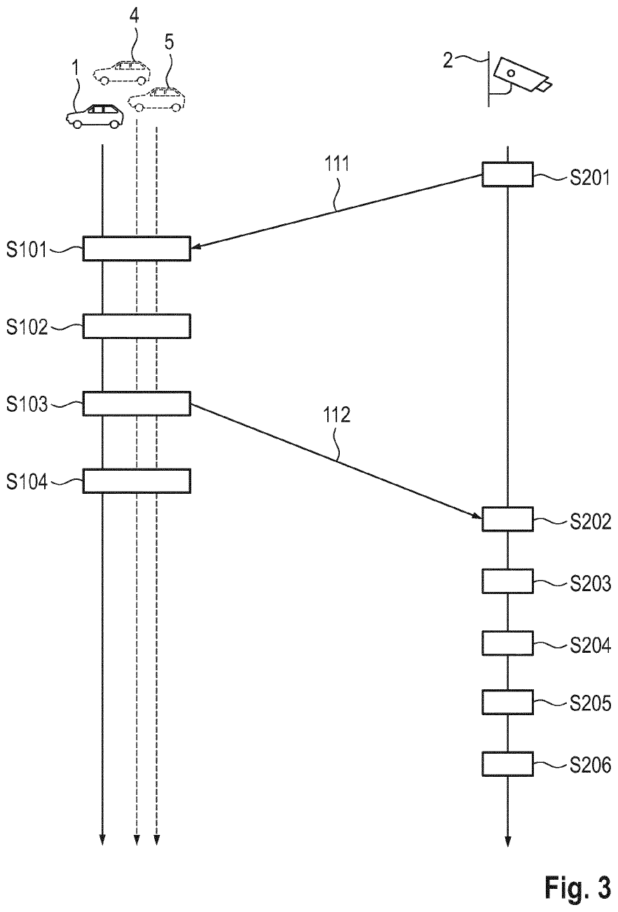

FIG. 3 shows an exemplary application for the method of a vehicle 1 and the method of a traffic infrastructure element 2 according to preferred specific embodiments of the present disclosure.

In the first method step S201, a first message 111 is transmitted by the traffic infrastructure element 2 to the vehicle 1 and is received by the vehicle 1 in the second step S102. The method is in particular also carried out by further vehicles 4, 5 located within the reception range of the traffic infrastructure element. In particular, the first message 111 is a collective perception message (CPM) according to the ETSI TR 103 562 or ETSI TS 103 324 standard. The first message 111 is based on a first sensor value ascertainable by the traffic infrastructure element. The first message 111 in particular includes the first sensor value.

In a third method step S102, a second sensor value corresponding to the first sensor value is ascertained by the vehicle 1. The two sensor values in particular relate to the vehicle 1 and are ascertained by at least one radar, LIDAR, sonar, GPS, odometry, inertial and/or camera sensor of the vehicle 1 or of the traffic infrastructure element 2.

In a fourth method step S103, a second message 112 is transmitted to the traffic infrastructure element 2 and received by the same in a further method step S202. The second message includes the second sensor value ascertained in the third method step S102.

In a fifth method step S104, a variance between the first sensor value and the second sensor value is determined by the vehicle 1. The variance is in particular determined as a difference between the first sensor value and the second sensor value. Moreover, further sensor values received from the traffic infrastructure element 2 are corrected based on the variance.

In a further method step S203, the traffic infrastructure element 2 likewise ascertains a variance based on the second message 112 and the first sensor value. In particular, the traffic infrastructure element 2 reads the second sensor value out of the second message 112 and ascertains a variance as a difference between the first and second sensor values.

In the eighth method step S204, the traffic infrastructure element 2 aggregates the variances in the form of variance data in a memory. Based on the variance data, the traffic infrastructure element 2 then triggers maintenance work in a ninth method step S205. In particular, the traffic infrastructure element 2 determines a mean variance based on the variance data, for example in the form of a mean value or a median of the variances, and triggers the maintenance work when the mean variance exceeds a specified limit value.

The traffic infrastructure element 2 then corrects further sensor values, which are detected by the sensor of the traffic infrastructure element 2, in a tenth method step S206 until the maintenance work has been carried out.

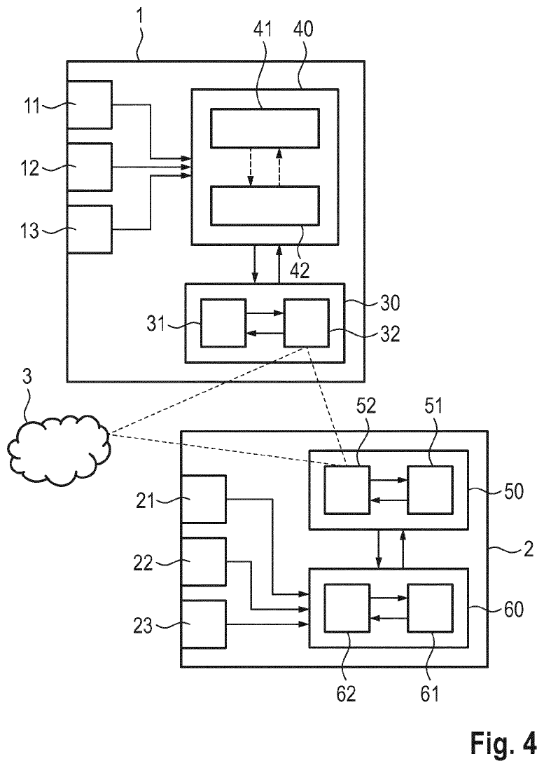

FIG. 4 shows a vehicle 1 and a traffic infrastructure element 2 according to preferred specific embodiments of the present disclosure.

The vehicle 1 comprises a plurality of first sensors 11, 12, 13, in particular a first sensor 11, a second sensor 12, and a third sensor 13. The sensors 11, 12, 13 are designed to detect surroundings data of the vehicle 1 and comprise, for example, a camera for detecting an image of a traffic situation located ahead of the vehicle 1, distance sensors, such as ultrasonic sensors, for detecting distances with respect to objects or further vehicles in the surroundings of the vehicle 1 or GPS sensors. The sensors 11, 12, 13 transmit the surroundings data detected by them to a control device 40 of the vehicle 1.

The control device 40 according to the present disclosure is designed to carry out the method of a vehicle according to the present disclosure, as described above. For this purpose, the control device 40 comprises an internal memory 41 and a CPU 42, which communicate with one another, for example via a suitable data bus. The control device 40 is furthermore communicatively connected to at least the sensors 11, 12, 13 and a communication module 30, for example via one or more respective CAN connections, one or more respective SPI connections, or other suitable data links.

The communication module 30 is composed of a memory 31 and one or more transceivers 32. The transceiver 32 is a radio, WLAN, GPS or Bluetooth transceiver or the like, in particular a transceiver that is designed for the communication in a network 3. The transceiver 32 communicates with the internal memory 31 of the communication module 30, for example via a suitable data bus. The communication module 30 also communicates with the control device 40, and in particular transmits to the same received data and/or receives from the same data to be sent. The communication module 30 is furthermore configured to communicate with a communication unit 50 of a traffic infrastructure element 2 via V2I communication, in particular via a network 3. Moreover, the communication module 30 can also be configured to communicate with one or more users of a system for autonomous driving, such as servers or further vehicles.

The network 3 is preferably a network according to the 3GPP standard, for example, an LTE, LTE-A (4G) or 5G communication network. The network 3 can furthermore be configured for the following operations or according to the following standards: High Speed Packet Access (HSPA), a Universal Mobile Telecommunication System (UMTS), UMTS Terrestrial Radio Access Network (UTRAN), evolved-UTRAN (e-UTRAN), Global System for Mobile communication (GSM), Enhanced Data rates for GSM Evolution (EDGE), or GSM/EDGE Radio Access Network (GERAN). As an alternative or in addition, the network 3 can also be designed according to any one of the following standards: Worldwide Interoperability for Microwave Access (WIMAX) network IEEE 802.16, and Wireless Local Area Network (WLAN) IEEE 802.11. In addition, the network 3 preferably employs one of the following coding methods: orthogonal frequency-division multiple access (OFDMA), time-division multiple access (TDMA), code-division multiple access (CDMA), wideband code division multiple access (WCDMA), frequency-division multiple access (FDMA) or space-division multiple access (SDMA) and the like.

The communication unit 50 of the traffic infrastructure element 2 is composed of a memory 51 and one or more transceivers 52. The transceiver 52 is a radio, WLAN, GPS or Bluetooth transceiver or the like, in particular a transceiver that is configured for the communication in a network 3. The transceiver 52 communicates with the internal memory 51 of the communication unit 50, for example via a suitable data bus. The communication unit 50 furthermore communicates with a control unit 60 of the traffic infrastructure element 2, for example via one or more respective CAN connections, one or more respective SPI connections or other suitable data links, in particular so as to transmit to the same received data and/or receive from these data to be sent.

The traffic infrastructure element 2 furthermore comprises a plurality of sensors 21, 22, 23, in particular a fourth sensor 21, a fifth sensor 22, and a sixth sensor 23. The sensors 21, 22, 23 are designed to detect data related to the vehicle 1 and comprise, for example, a camera for detecting an image of a traffic situation located around the vehicle 1, distance sensors, such as ultrasonic sensors, or GPS sensors. The sensors 21, 22, 23 transmit the sensor data detected by them to a control unit 60 of the traffic infrastructure element 2.

The control unit 60 according to the present disclosure is configured to carry out the method of a traffic infrastructure element according to the present disclosure as described above. For this purpose, the control unit 60 comprises a memory 61 and a CPU 62, which communicate with one another, for example via a suitable data bus.

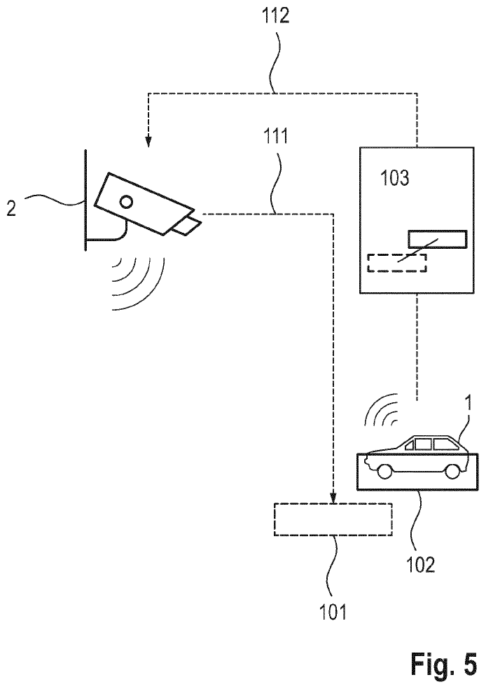

FIG. 5 shows a further exemplary application of the vehicle and of the traffic infrastructure element according to preferred specific embodiments of the present disclosure.

The traffic infrastructure element 2 detects a first sensor value 101, in particular a position 101 of the vehicle 1. The traffic infrastructure element 2 furthermore sends a first message 111 to the vehicle 1. The first message 111 is based on the first sensor value 101. The vehicle 1 likewise detects the position thereof as a second sensor value 102 and determines a variance 103 based on the first and second sensor values 101, 102. The vehicle 1 additionally sends a second message 112 to the traffic infrastructure element 2. The second message 112 includes the variance 103.

### LIST OF REFERENCE SIGNS

1 vehicle
2 traffic infrastructure element
3 network
4 second vehicle
5 third vehicle
11 first sensor
12 second sensor
13 third sensor
101 first sensor value
102 second sensor value
103 variance
111 first message
112 second message
21 fourth sensor
22 fifth sensor
23 sixth sensor
30 communication module
31 internal memory
32 transceiver
40 control device
41 internal memory
42 CPU
50 communication unit
51 internal memory
52 transceiver
60 control unit
61 memory
62 CPU
S101 second method state
S102 third method step
S103 fourth method step
S104 fifth method state
S201 first method step
S202 sixth method step
S203 seventh method state
S204 eighth method step
S205 ninth method step
S206 tenth method step

1-10. (canceled)

11. A method for a vehicle, comprising:
receiving a first message from a traffic infrastructure element, the first message being based on a first sensor value obtained by the traffic infrastructure element;
obtaining a second sensor value corresponding to the first sensor value; and
transmitting a second message to the traffic infrastructure element, the second message being based on the second sensor value.

12. The method of claim 11, further comprising: determining a variance between the first sensor value and the second sensor value, wherein the first message comprises the first sensor value, and the second message is based on the variance.

13. The method of claim 12, wherein the first message comprises sensor-based information regarding a plurality of vehicles, the method further comprising: obtaining vehicle-specific information based on the first message; and determining the variance based on the vehicle-specific information and the second sensor value.

14. The method of claim 12, further comprising: correcting further sensor values received from the traffic infrastructure element based on the variance.

15. The method of claim 12, further comprising: evaluating further messages received from the traffic infrastructure element only when the variance is below a predetermined threshold value.

16. The method of claim 12, wherein the first message comprises a first derivative value based on the first sensor value, the method further comprising: calculating a second derivative value based on the second sensor value; and determining the variance as a difference between the first derivative value and the second derivative value.

17. The method of claim 16, wherein the first derivative value is a position calculated from the first sensor value obtained by a distance sensor of the traffic infrastructure element, and the second derivative value is a position calculated from the second sensor value obtained by a GPS sensor of the vehicle.

18. A method for a traffic infrastructure element, comprising:
transmitting a first message to at least one vehicle, the first message being based on a first sensor value obtained by a sensor of the traffic infrastructure element; and
receiving a second message from the at least one vehicle, the second message being based on a second sensor value obtained by the at least one vehicle and corresponding to the first sensor value.

19. The method of claim 18, further comprising: determining a variance based on the second message and the first sensor value obtained by the sensor.

20. The method of claim 18, wherein the first message comprises the first sensor value obtained by the sensor, and the second message comprises a variance based on the second sensor value obtained by the at least one vehicle and the first sensor value.

21. The method of claim 20, further comprising: aggregating the variance as variance data in a memory of the traffic infrastructure element.

22. The method of claim 21, further comprising: triggering maintenance of the traffic infrastructure element based on the variance data; or correcting further sensor values obtained by the sensor based on the variance data.

23. The method of claim 21, further comprising: determining a mean variance based on the variance data, wherein the mean variance is calculated as a mean or median of the variance data aggregated from a plurality of vehicles.

24. The method of claim 19, wherein the first message comprises a first derivative value based on the first sensor value, and the second message comprises a second derivative value based on the second sensor value, the method further comprising: determining the variance as a difference between the first derivative value and the second derivative value.

25. A vehicle, comprising:
a sensor configured to obtain a sensor value; a communication module configured for wireless communication with a traffic infrastructure element; and
a control device configured to:
receive a first message from the traffic infrastructure element, the first message being based on a first sensor value obtained by the traffic infrastructure element;
obtain a second sensor value via the sensor, the second sensor value corresponding to the first sensor value; and transmit a second message to the traffic infrastructure element via the communication module, the second message being based on the second sensor value.

26. The vehicle of claim 25, wherein the control device is further configured to: determine a variance between the first sensor value and the second sensor value, wherein the first message includes the first sensor value, and the second message is based on the variance.

27. The vehicle of claim 26, wherein the control device is further configured to: correct further sensor values received from the traffic infrastructure element based on the variance.

28.The vehicle of claim 26, wherein the first message includes sensor-based information regarding a plurality of vehicles, and the control device is further configured to: obtain vehicle-specific information based on the first message; and determine the variance based on the vehicle-specific information and the second sensor value.

29. The vehicle of claim 26, wherein the first message includes a first derivative value based on the first sensor value, and the control device is further configured to: calculate a second derivative value based on the second sensor value; and determine the variance as a difference between the first derivative value and the second derivative value.

30. The vehicle of claim 29, wherein the first derivative value is a position calculated from the first sensor value obtained by a distance sensor of the traffic infrastructure element, and the second derivative value is a position calculated from the second sensor value obtained by a GPS sensor of the vehicle.
